(19) United States
(12) Patent Application Publication
(10) Pub. No.: US 2015/0308128 A1
(43) Pub. Date: Oct. 29, 2015

(54) A SERVICE DUCT AND SPACER SYSTEM

(71) Applicant: LIFTING POINT PTY LTD, Penrith, New South Wales (AU)

(72) Inventor: Nicholas Bruce MULLANEY, Marulan, New South Wales (AU)

(73) Assignee: LIFTING POINT PTY LTD, Penrith, New South Wales (AU)

(21) Appl. No.: 14/650,265

(22) PCT Filed: Dec. 11, 2012
(86) PCT No.: PCT/AU2012/001509

§ 371 Date: Jun. 5, 2015

(51) Int. Cl. E04F 17/08; H02G 3/38; E04C 1/39; E04B 1/41; E04B 2/72

(52) U.S. Cl. CPC E04F 17/08; E04B 1/40; E04B 2/721; E04C 1/397; H02G 3/288

(57) ABSTRACT

A service duct and spacer, for use in the service duct and spacer system, is provided including an extruded elongate body portion having a first panel engaging portion spaced apart from a second panel engaging portion and a mid-portion situated between the first and second panel engaging portions. The mid-portion is hollow and defines an interior space by way of sidewalls and bases. Service utilities are able to be located within the interior space. Sidewall is able to be removed in order to gain access into the interior space so that the service utilities can be maintained, introduced and/or removed from the body portion. Each panel engaging portion consists of a base and two spaced apart legs extending away from the base so as to define a wall engaging area for accommodating and supporting a portion of a wall panel.

### CROSS-REFERENCE TO RELATED APPLICATION

This application is the U.S. national phase of PCT Application No. PCT/AU12/001509 filed on Dec. 11, 2012, the disclosure of which is incorporated in its entirety by reference herein.

### TECHNICAL FIELD

The invention relates to a service duct and spacer system situated between two aligned panels of a building structure, typically, but not limited thereto, a building structure erected from shipping containers. The invention also relates to a building structure that includes two aligned panels and a service duct and spacer system situated between the two aligned panels.

### BACKGROUND

There is a need for a duct and spacer system for the installation and travel of services to their required termination points so as to reduce the cost associated with the installation and maintenance of service utilities within duct systems.

Generally when services are run they are between the external surface and the internal surface of the wall and the two surfaces are separated leaving a void, however this type of wall construction is time consuming and costly and traps services within the two wall skins.

Also there can be requirements for services to be installed and be retained within the void as a near complete assembled unit so as to avoid damage to the services during transport and installation stages. It is also common to install services where they protrude past the front surface of a wall.

Currently services are run behind the wall surface. It is common to provide surface mounted ducting systems, but these can be clumsy and interfere with furniture and fittings and are not physically pleasing. They can also be easily damaged during construction. They are generally used in situations where regular maintenance or upgrade is required such as in commercial offices, however are not generally adopted and accepted in residential buildings.

In some prior art arrangements conduits are stored behind the wall surfaces and required cables can be upgraded by pulling wires through the conduit. This is an awkward process because the conduit is typically hidden with tight bends and damage to the conduit can create difficulty.

With the advent of laminated panels that generally have a thickness of 50 mm or greater these are being more commonly used in building and are designed to include “H” joiners that are intended to allow no void between the panels and are not designed to carry services as it will alter and reduce the intended properties of the wall panel such as thermal properties. As a result services are normally run on the surface or behind such laminated panels.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### SUMMARY

The invention is concerned with providing a service duct and spacer system that ameliorates some of the disadvantages and limitations of the known art or at least providing the public with a useful choice.

The invention resides in a service duct and spacer system having a serviceable cavity when the service duct and spacer system is situated between and structurally supports two aligned panels of a building structure, the service duct and spacer system having an elongate body portion including:

a first panel engaging portion adapted to engage a longitudinal end of a first panel, the first panel engaging portion having a base and two spaced upstanding legs such that the longitudinal end of the first panel is able to be situated between the two upstanding legs such that the first panel engaging portion retains the first panel;

a second panel engaging portion adapted to engage a longitudinal end of a second panel, the second panel engaging portion having a base and two spaced upstanding legs such that the longitudinal end of the second panel is able to be situated between the two upstanding legs such that the second panel engaging portion retains the second panel; and

a mid-portion situated between the first and second panel engaging portions, the mid-portion defining an interior space that is adapted to act as the serviceable cavity in which service utilities are able to be located therein, the mid-portion having at least a first sidewall extending between each base of the first and second panel engaging portions, the first sidewall being axially aligned with one of the upstanding legs of each first and second panel engaging portions such that an outer surface of the first sidewall is substantially planar with an outer surface of said upstanding legs; the first sidewall being removably attachable to the mid-portion so as to allow access into the interior space such that the service utilities can be maintained, introduced and/or removed from the body portion, wherein in use the service duct and spacer system structurally support the panels vertically or horizontally when used in either vertical or horizontal orientations.

Preferably, the service utilities include at least one of: electrical cables; telecommunication cables; water pipes; heating ducts; air-conditioning ducts; and/or other required services.

Preferably, the body portion includes preassembled electrical cables, telecommunication cables, water pipes, heating and air-conditioning ducts therein, whereby the preassembled electrical cables, telecommunication cables, water pipes, heating and air-conditioning ducts are adapted to be coupled with corresponding preassembled electrical cables, telecommunication cables, water pipes, heating and air-conditioning ducts situated within an adjacent body portion.

Preferably, the mid-portion has at least one tray extending longitudinally within the interior space.

Preferably, the mid-portion has at least a second sidewall extending between each base of the first and second panel engaging portions and the second sidewall is axially aligned with another of the upstanding legs of each first and second panel engaging portion, such that the second sidewall is spaced apart from the first sidewall.

Preferably, the removable sidewall is snap fittingly engageable the body portion.

Preferably, the mid-portion has a side wall that is indented inwards relative to the upstanding legs of first and second panel engaging portions to define an open cavity sized to accommodate insulation therein.

Preferably, the height of the elongate body portion is adjustable such that the combined height of the two aligned panels with the service duct and spacer system situated there between can be adjusted to suit the height requirements of a wall or ceiling of a building structure.

Preferably, the width of the elongate body portion is adjustable such that the combined width of the two aligned panels with the service duct and spacer system situated there between can be adjusted to suit the width requirements of a wall or ceiling of a building structure.

Preferably, the ducting and spacer system acts as a spacer between the two wall panels such that extra wall height or wall width is able to be obtained.

Preferably, each sidewall of the mid-portion includes two parts that are able to be raised up and down relative to one other so as to achieve a desired height of the elongate body portion and be held at that height by fastening means.

Preferably, the sidewalls of the mid-portion are corrugated to allow the height of the elongate body portion to be adjusted by extension of the corrugations.

Preferably, the elongate body portion includes a size adjustable spacer situated in one of the cavities of the first and second engaging wall portions, wherein the size adjustable spacer is positioned between the base of an engaging wall portion and the wall panel so that as the size adjustable spacer expands the wall panel moves away from the elongate body portion allowing the overall height of the combined wall panels and duct and spacer to be adjusted.

Preferably, wall panels can be situated and held in place anywhere along the legs of the first and second engaging wall portions so that the wall panels can be held in place at a desired position therein in order to achieve the desired height of the combined wall panels with the duct and spacer system.

Preferably, the panel engaging portions include sealing means to sealingly engage with the panels so as to create a fluid tight seal.

Preferably, the sealing means are situated only on the panel engaging portions that contact with a surface of the panels that are to be situated on the exterior of a building such that the duct and spacer system is weather proof

Preferably, the sealing means is adapted to seal against the ingress and/or egress of fluid.

Preferably, the structural supporting of the panels vertically or horizontally is effected by the elongate body portion including vertical, horizontal and/or diagonal support members.

Preferably, the vertical, horizontal and/or diagonal support members are situated within the interior space of the elongate body portion.

Preferably, the mid-portion is of a unitary construction, with exception of the removable sidewall, so as to provide structural support due to the greater strength properties provided by a unitary construction.

The invention also resides in a service duct and spacer system having a serviceable cavity when the service duct and spacer system is situated between and structurally supports two aligned panels of a building structure, the service duct and spacer system having an elongate body portion where the body portion includes:
(i) an H-shaped first panel engaging portion for accommodating and holding a wall panel within the opening of the upper part of the H-shape and
(ii) a U-shaped second panel engaging portion where the upper portions of the legs of the U-shape extend into the opening of the lower part of the H-shape of the first engaging panel portion and are adjacent the lower part of the legs of the H-shaped first panel engaging portion and define an interior space that is adapted to act as the serviceable cavity in which service utilities are able to be located therein, wherein the outer surface of the U-shaped second engaging portion is dimensioned to fit within a cavity situated in the upper portion of a wall panel so that the wall panel is able to be attached in use to the U-shaped second engaging portion and further wherein the service duct and spacer system is able to structurally support the panels vertically or horizontally when in used either vertical or horizontal orientations.

Preferably, the elongate body portion is adapted to be joined and aligned with a corresponding adjacent duct elongate body portion.

Preferably, the panel engaging portions include sealing means to sealingly engage with the panels so as to create a fluid tight seal.

Preferably, the sealing means are situated only on the panel engaging portions that contact with a surface of the panels that are to be situated on the exterior of a building such that the duct and spacer system is weather proof

Preferably, the structural supporting of the panels vertically or horizontally is effected by the elongate body portion including vertical, horizontal and/or diagonal support members.

Preferably, the vertical, horizontal and/or diagonal support members are situated within the interior space of the elongate body portion.

The invention also resides in a building structure including two aligned panels and the above-described service duct and spacer system situated between the two aligned panels.

The invention also resides in any other aspect as herein described.

### BRIEF DESCRIPTION OF THE DRAWINGS

The invention will now be described, by way of example only, by reference to the accompanying drawings:

FIG. 1 is a cross-sectional view of an extrusion used in the service duct and spacer system in accordance with a first embodiment of the invention.

FIG. 2 is a cross-sectional view of the extrusion shown in FIG. 1 attached to two corresponding wall panels.

FIG. 3 is a cross-sectional view of the extrusion shown in FIG. 2 with snap fit lid removed.

FIG. 4 is a cross-sectional view of an extrusion used in the service duct and spacer system in accordance with a second embodiment of the invention.

FIG. 5 is a cross-sectional view of an extrusion used in the service duct and spacer system in accordance with a third embodiment of the invention.

FIG. 6 is a cross-sectional view of an extrusion used in the service duct and spacer system in accordance with a fourth embodiment of the invention.

FIG. 7 is a cross-sectional view of an extrusion used in the service duct and spacer system in accordance with a fifth embodiment of the invention.

FIG. 8 is a cross-sectional view of an extrusion used in the service duct and spacer system in accordance with a sixth embodiment of the invention.

FIG. 9 is a cross-sectional view of an extrusion used in the service duct and spacer system in accordance with a seventh embodiment of the invention.

FIG. 9A is a variation of the seventh embodiment of the service duct and spacer system shown in FIG. 9.

FIG. 9B is a perspective view of the service duct and spacer system shown in FIG. 9A

FIG. 10 is a cross-sectional view of an extrusion used in the service duct and spacer system in accordance with an eighth embodiment of the invention.

FIG. 11 is a perspective view of a T-shaped connector to be used with the service duct and spacer system in accordance with aforementioned embodiments of the invention.

FIG. 12 is a side view of an air-conditioning duct to be used with the service duct and spacer system in accordance with aforementioned embodiments of the invention.

FIG. 12A is a side view of an air-conditioning duct to be used with the service duct and spacer system in accordance with aforementioned embodiments of the invention.

FIG. 12B is a perspective view of a further air-conditioning duct to be used with the service duct and spacer system in accordance with aforementioned embodiments of the invention.

FIG. 12C is a cross-sectional view of the service duct and spacer system shown in FIG. 12B.

FIG. 12D is a cross-sectional view of a further air-conditioning duct to be used with the service duct and spacer system in accordance with aforementioned embodiments of the invention.

FIG. 12E is a perspective view of the service duct and spacer system shown in FIG. 12D.

FIG. 13 is a cross-sectional side view of a service duct and spacer system in accordance with a ninth embodiment of the invention.

FIG. 13A is a perspective view of the ninth embodiment of the service duct and spacer system shown in FIG. 13.

FIG. 13B is a perspective view of a variation of the ninth embodiment of the service duct and spacer system shown in FIG. 13.

FIG. 13C is a cross-sectional view of the service duct and spacer system shown in FIG. 13B.

FIG. 13D is a perspective view of a variation of the ninth embodiment of the service duct and spacer system shown in FIG. 13.

FIG. 13E is a cross-sectional view of the service duct and spacer system shown in FIG. 13D.

FIG. 14 is a cross-sectional view of the service duct and spacer system in accordance with a tenth embodiment of the invention.

FIG. 14A is a perspective view of the service duct and spacer system shown in FIG. 14.

FIG. 15 is a perspective view of the service duct and spacer system in accordance with an eleventh embodiment of the invention.

FIG. 16 is a cross-sectional view of the service duct and spacer system shown in FIG. 15.

FIG. 17 is a cross-sectional view of the service duct and spacer system in accordance with a twelfth embodiment of the invention.

FIG. 18 is a perspective view of the service duct and spacer system in accordance with a thirteenth embodiment of the invention.

FIG. 18A is a cross-sectional view of the service duct and spacer system shown in FIG. 18.

FIG. 18B is a perspective view of the service duct and spacer system shown in FIG. 18 in a vertically adjusted state.

FIG. 18C is a cross-sectional view of the service duct and spacer system shown in FIG. 18B.

FIG. 19 shows a building in accordance with an embodiment of the invention incorporating the service duct and spacer system in accordance with aforementioned embodiments of the invention.

FIG. 20 is a cross-sectional view of the service duct and spacer system in accordance with a fourteenth embodiment of the invention.

FIG. 21 is a cross-sectional view of the service duct and spacer system in accordance with a fifteenth embodiment of the invention.

FIG. 21A is a perspective view of the service duct and spacer system shown in FIG. 21.

FIG. 22 is a cross-sectional view of the service duct and spacer system in accordance with a sixteenth embodiment of the invention.

FIG. 22A is a perspective view of the service duct and spacer system shown in FIG. 22.

FIG. 23 is a cross-sectional view of the service duct and spacer system in accordance with a seventeenth embodiment of the invention.

FIG. 23A is a perspective view of the service duct and spacer system shown in FIG. 23.

### DETAILED DESCRIPTION

The following description will describe the invention in relation to embodiments of the invention, namely a service duct and spacer system situated between two aligned panels of a building structure and a building structure that includes the service duct and spacer system. The invention is in no way limited to these embodiments as they are purely to exemplify the invention only and that possible variations and modifications would be readily apparent without departing from the scope of the invention.

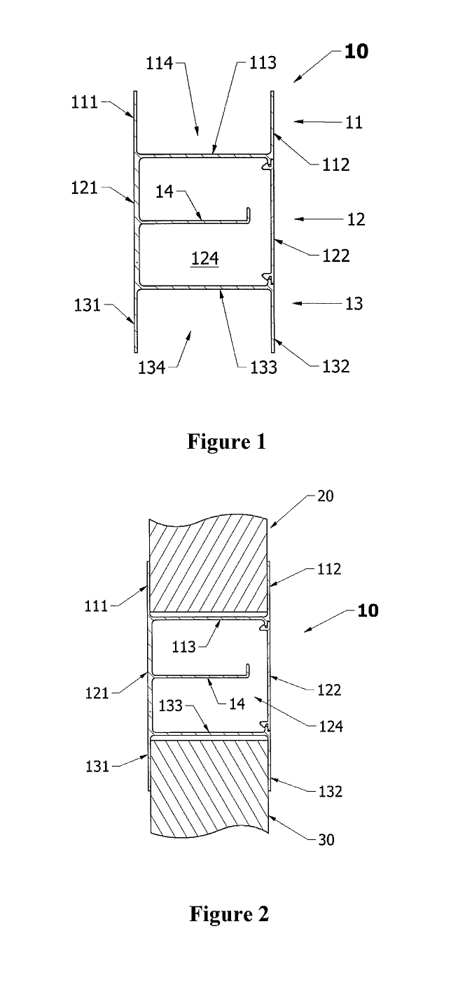

FIGS. 1, 2 & 3 show a service duct and spacer 10 for use in the service duct and spacer system of the invention. The service duct and spacer 10 has an elongate body portion 10 having a first panel engaging portion 11 spaced apart from a second panel engaging portion 13 whereby a mid-portion 12 is situated between the first and second panel engaging portions 11, 13. The elongate body 10 can be extruded, rolled, formed, pressed, 3D printed or formed using any other suitable manufacturing process.

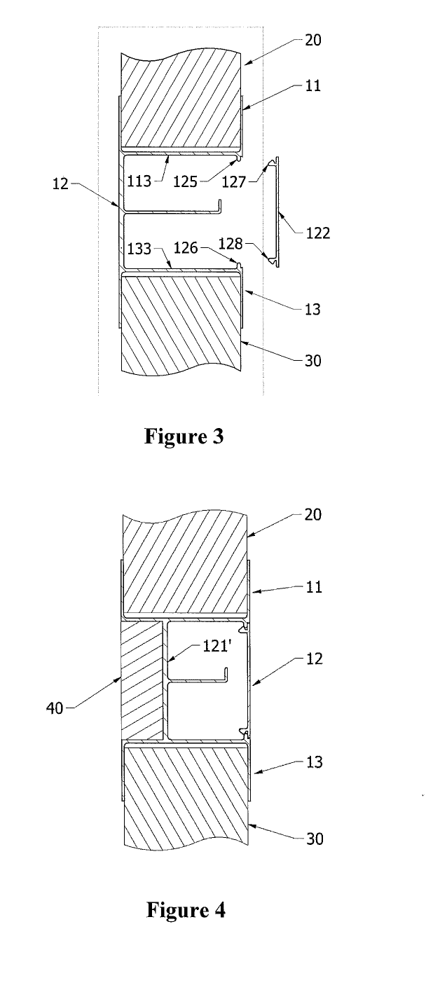

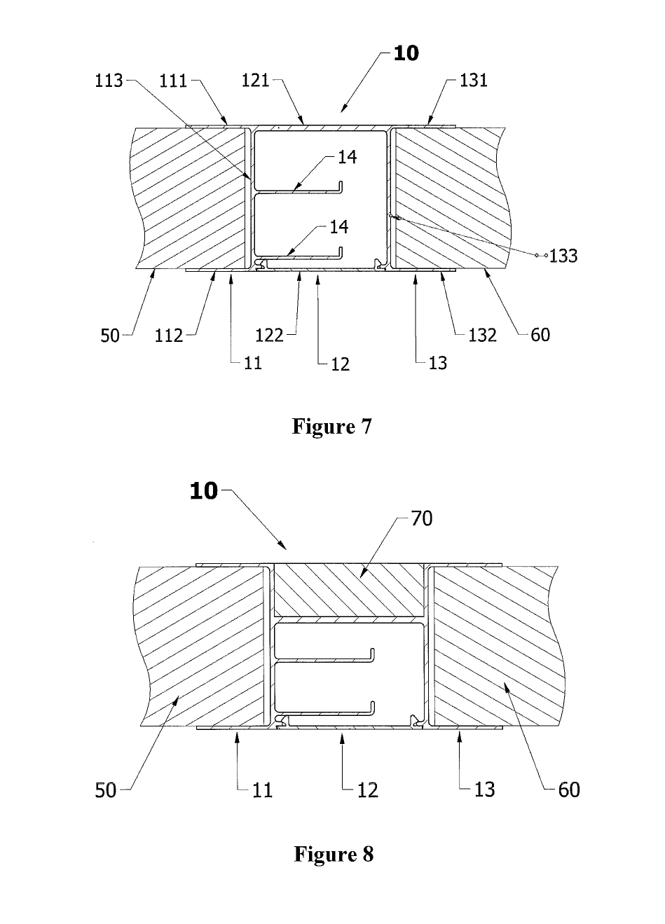

The mid-portion is hollow and defines an interior space 124 by way of sidewalls 121, 122 and bases 113, 133. Service utilities are able to be located within the interior space 124. Sidewall 122 is able to be removed (see FIG. 3) in order to gain access into the interior space 124 so that the service utilities can be maintained, introduced and/or removed from the body portion 10. Each panel engaging portion 11, 13 consists of a base 113, 133 and two spaced apart legs 111, 112 & 131, 132 extending away from the base 113, 133 so as to define an wall engaging area 114, 134 for accommodating and supporting a portion of a wall panel 20, 30 (as is shown in FIGS. 2 and 3). A tray 14 extending outwardly away from side wall 121 can be situated within the interior space 124 of the body portion 10 where the tray can be used to hold and position service utilities off the base 133. The interior space can accommodate more than one tray as is shown in FIG. 7. The sidewall 122 is removably attached to the mid-portion by way of connections 127 & 128 on the sidewall 122 that engage in a snap fit manner with corresponding connections 125 and 126 situated on the bases 113 & 133 respectively. It is envisaged that other known ways of removably attaching the sidewall 122 to the mid-portion 12 can be utilized, such as releasable fasteners, etc.

FIG. 4 is an alternative to the duct and spacer as shown in FIGS. 1 to 3, in that the duct and spacer shown in FIG. 4 is modified in order to accommodate insulation or other material. The body portion has a mid-portion 12 that has a side wall 121′ that is indented inwards relative to the sidewalls 111, 131 of first and second panel engaging portions 11, 13 to define an open cavity sized and dimensioned to accommodate insulation 40 therein (compared to sidewall 121 shown in FIGS. 1 to 3 which is aligned and flush with the sidewalls 111, 131 of first and second panel engaging portions 11, 13). FIGS. 6 & 8 show other alternatives of the duct and spacer capable of accommodating insulation 40 therein in a similar arrangement to that shown in FIG. 4.

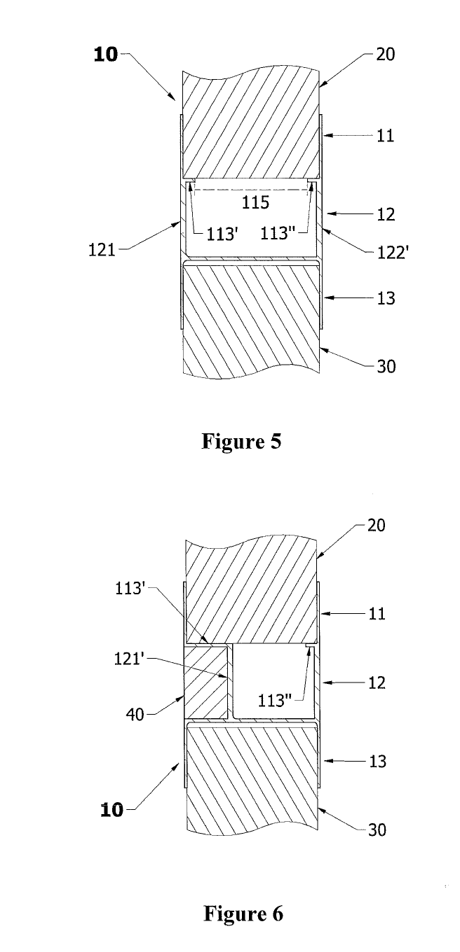

FIGS. 5 and 6 show an alternative version of the duct and spacer where the removable sidewall 122 shown in FIGS. 1 to 4 is replaced by a fixed sidewall 122′ and base 113 of the first panel engaging portion 11 shown in FIGS. 1 to 4 is replaced with flanges 113′ & 113″ to define an opening 115 through which the interior of the mid-portion 12 is able to be accessed prior to wall panel 20 being situated in and held by the first engaging panel portion 11.

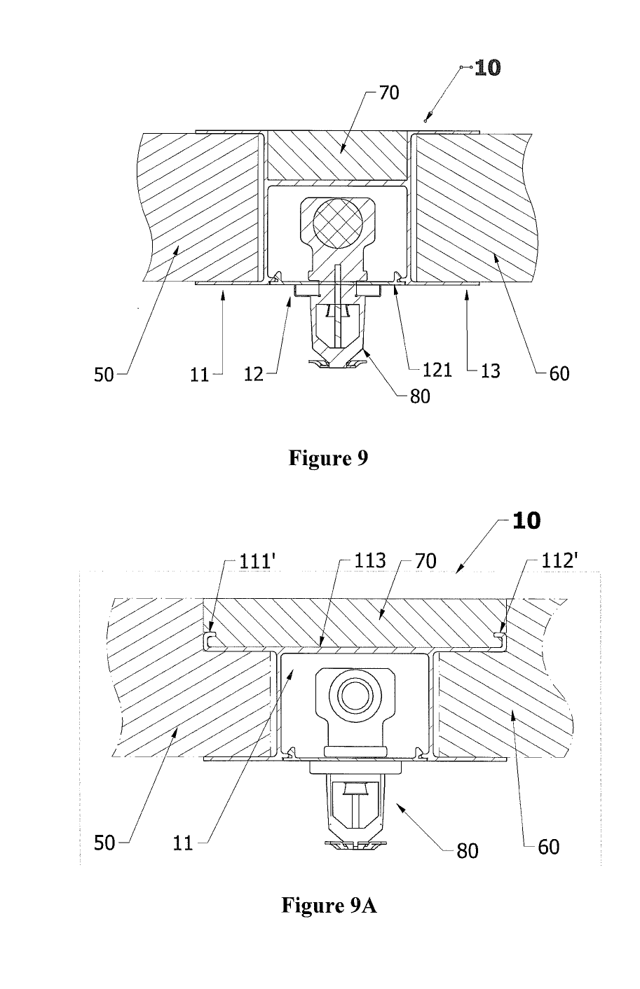

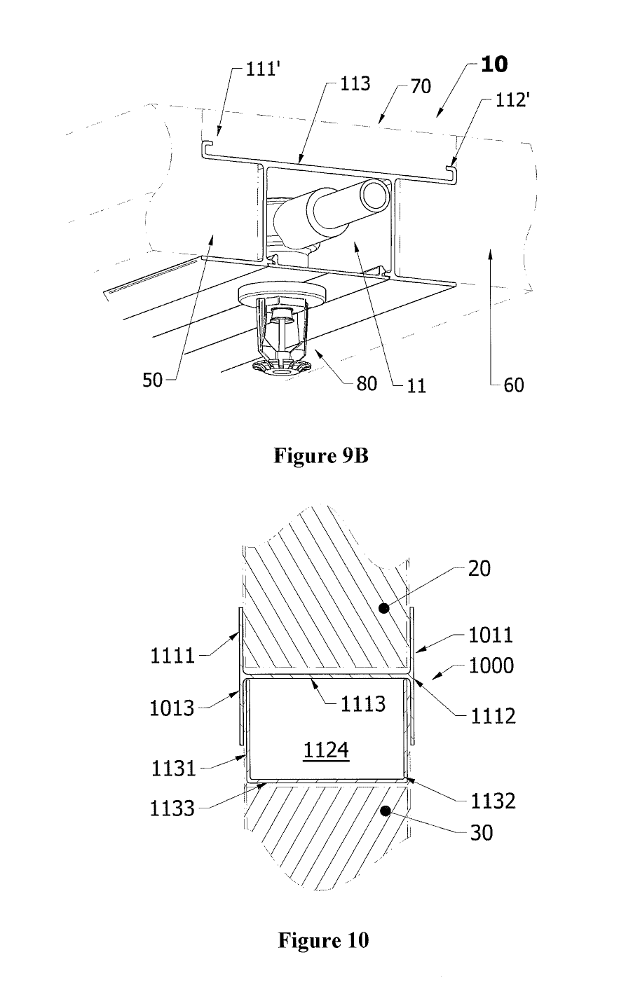

FIGS. 1 to 6 show the duct and spacer 10 being used in respect of vertical walls, however it is envisaged that the duct and spacer 10 can be used horizontally such as floors and ceilings. FIGS. 7, 8 and 9 show alternative versions of the duct and spacer 10 used horizontally between two aligned ceiling panels 50, 60 and having two trays 14 within interior space of the mid-portion 12. FIG. 8 is a duct and spacer system accommodating insulation 70. FIGS. 9, 9A and 9B are similar to that of FIG. 8, however instead of having trays the mid-portion 12 incorporates a fire sprinkler 80. All other parts shown in FIG. 7 are identical to those shown in FIGS. 1 to 3 and all other parts shown in FIGS. 8 & 9 are identical to those shown in FIG. 4. FIGS. 9A and 9B have leg portions 111′, 112′ that support and hold the wall panels 50, 60 and the insulation 70 in place.

FIG. 10 shows a further embodiment of the duct and spacer system where the duct and spacer 1000 consists of an H-shaped first panel engaging portion 1011 for accommodating and holding a wall panel 20 within the opening of the upper part of the H-shape. The duct and spacer 1000 includes a U-shaped second panel engaging portion 1013 where the upper portions of the legs 1131, 1132 of the U-shape extend into the opening of the lower part of the H-shape of the first engaging panel portion 1011 and are adjacent to the lower part of the legs 1111, 1112 of the H-shaped first panel engaging portion 1011. The outer surface of the U-shaped second engaging portion 1013 is dimensioned to fit within a cavity situated in the upper portion of the wall panel 30 so that the wall panel is able to be attached to the U-shaped second engaging portion 1013.

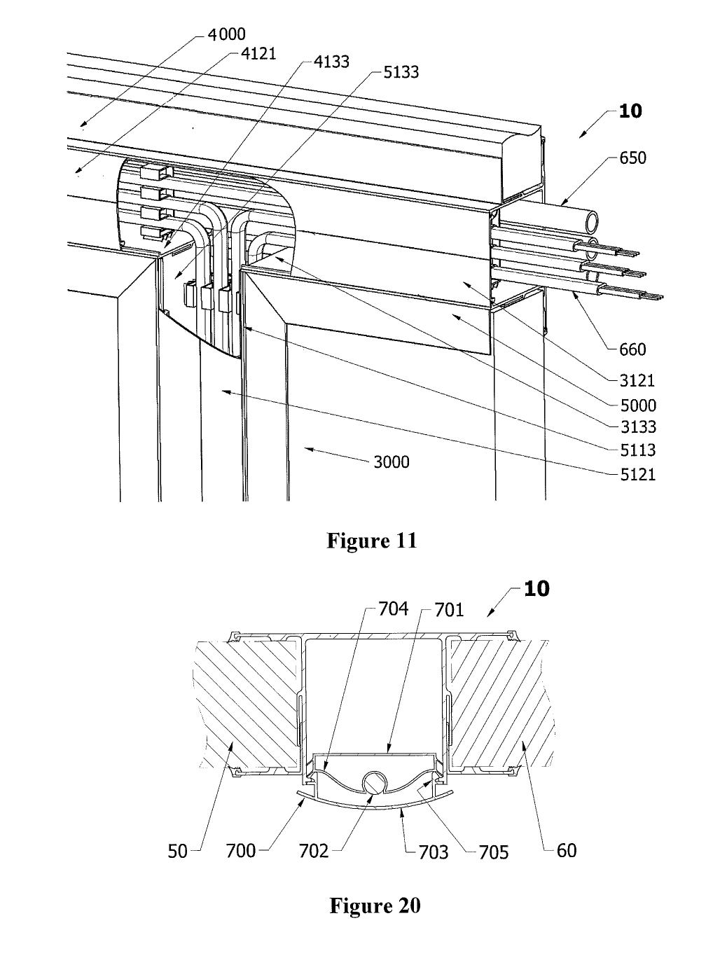

FIG. 11 shows preferred T joint connection of a service duct and a spacer 10 with pipes 650 and cables 660 therein. FIG. 11 shows a T connection arrangement where the walls are aligned in the same plane, however it is envisaged that shaped connections such as right angle connections can be readily configured and used. The duct and spacer system of FIG. 11 has duct and spacer 10 portions 3000, 4000 and 5000 with corresponding side walls 3121, 4121, 5121 and bases 3133, 4133, 5133 in the form a T shape that define an internal space in which pipes 650 and cables 660 can be situated.

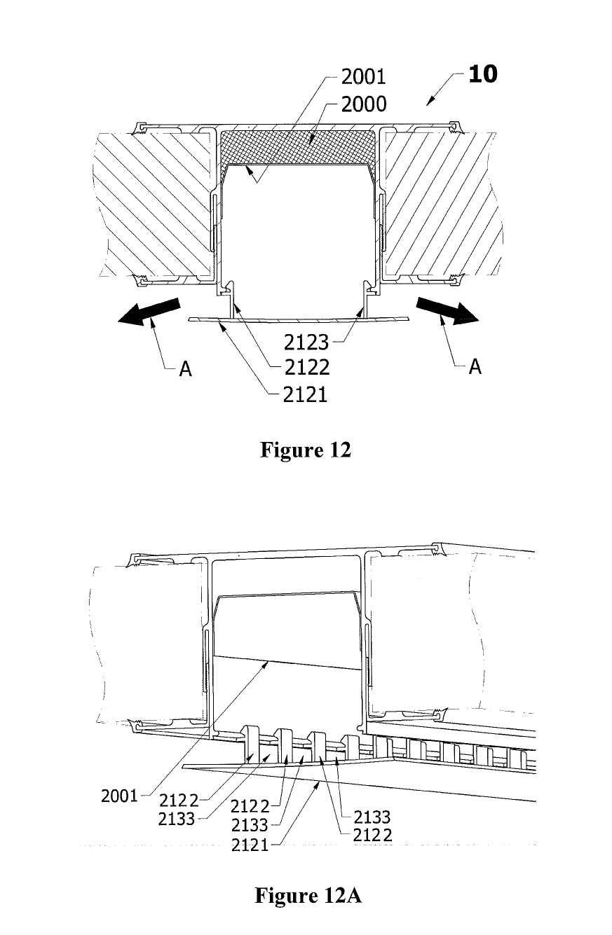

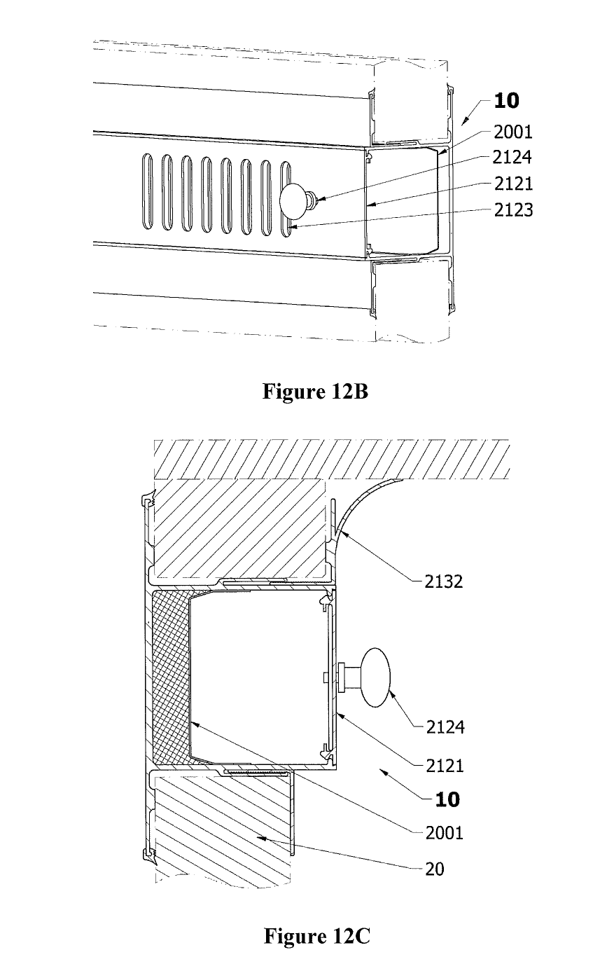

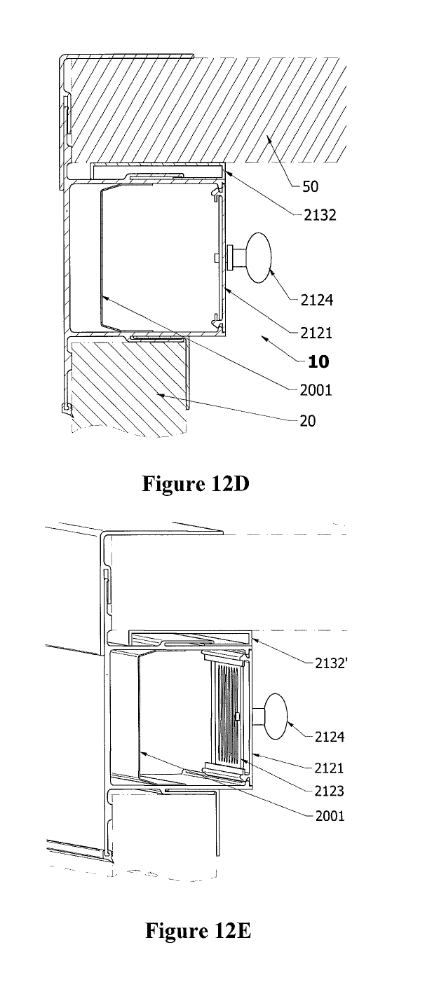

FIGS. 12 to 12E show preferred air conditioning duct arrangements that are intended to be situated and used within the duct and spacer system. FIGS. 12 & 12A show air-conditioning arrangements utilized within the duct and spacer 10 used in a ceiling or roof. The duct and spacer 10 has an elongate side panel 2121 spaced a distance from the duct and spacer 10 by a plurality of vertically spaced apart feet 2122, 2123 where the space between the feet 2122, 2123 define openings 2133 that allow air conditioned air A to flow out from within the internal space of the duct and spacer 10 in to a room. The cross-sectional area of the internal space within the elongate body of the duct and spacer 10 lessens in the direction of air flow through the internal space within the elongate body of the duct and spacer 10 so as to maintain a constant air flow exiting through openings 2123 along the length of the duct and spacer 10. This can be achieved by the combination of a C-shaped insert 2001 and packing 2000. FIGS. 12B to 12E show a variation of an air-conditioning arrangement utilized within the duct and spacer 10 used within a wall. The side panel 2121 consists of a plurality of spaced openings 2123 to allow air flow to pass out from within the internal space of the duct and spacer 10 into a room. A handle 2124 on the side panel 2121 allows for the openings 2123 to be closed or the area to be varied to restrict the air flow. In FIG. 12C a portion 2132 depends from duct and spacer 10 up to and in contact with the ceiling/roof. In FIG. 12E portion 2132 acts as a spacer between the duct and spacer 10 and the ceiling panel 50.

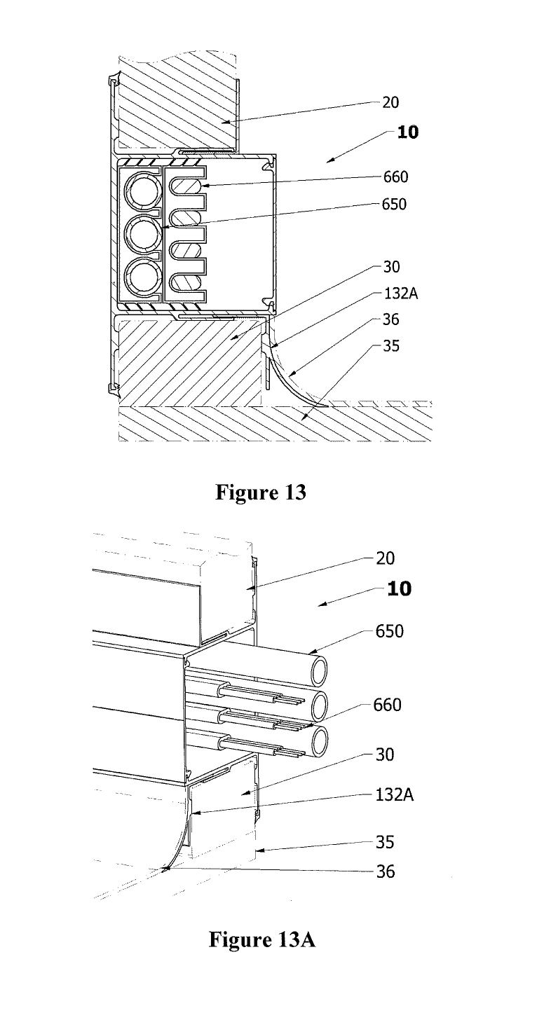

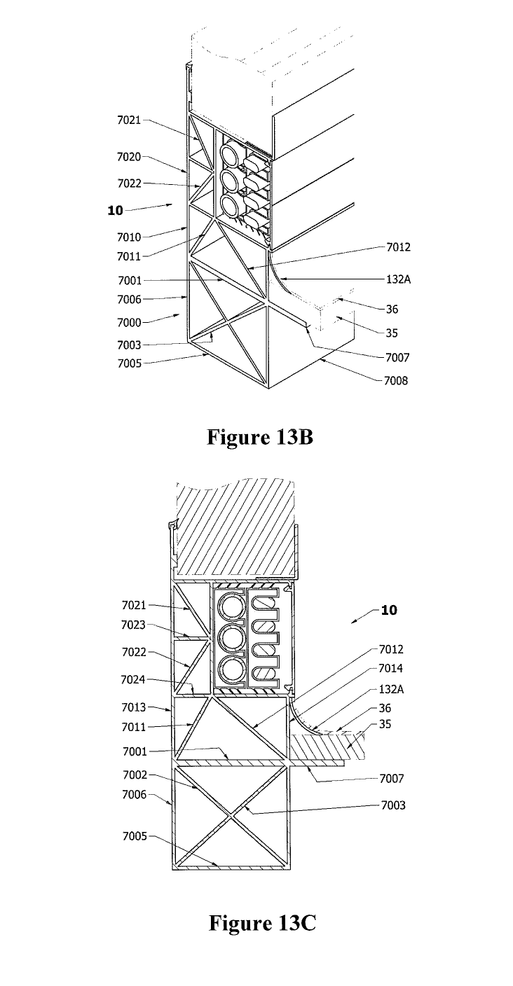

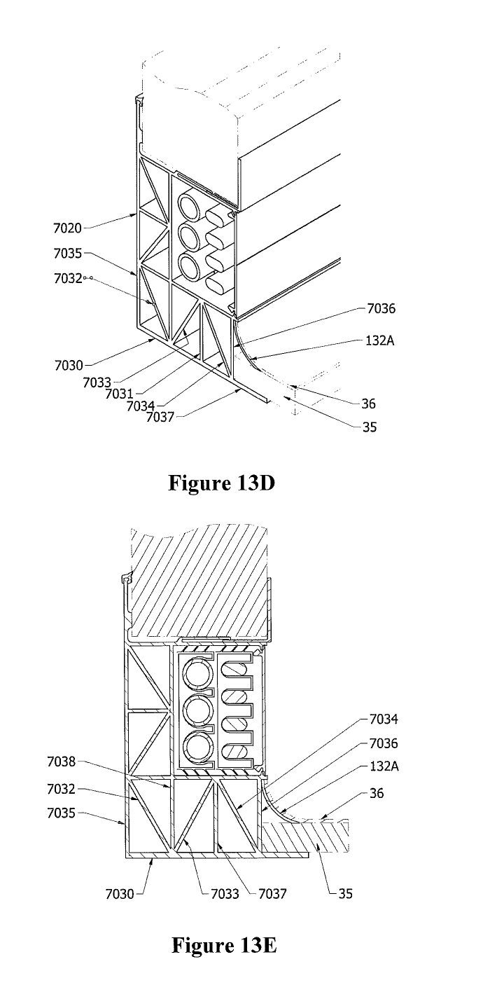

FIGS. 13 to 13E show a variation of the duct and spacer 10 when used adjacent to the floor. The duct and spacer 10 is shown in FIGS. 13 and 13A supporting and utilizing cables 660 and pipes 650 within the internal space of the elongate body of the duct and spacer 10. The duct and spacer 10 supports a wall panel 20 at its upper region and is supported on lower wall panel 30 situated on a floor 35. A curved portion 132 depends downwardly from the duct and spacer 10 and contacts with the floor upon which a floor covering 36 (such linoleum or carpet) is situated. The curved portion 132 acts in the same as a kick back. FIGS. 13B to 13E show a variation on FIGS. 13 and 13A whereby the lower wall panel 30 is not required as the duct and spacer 10 includes “box” type support elements 7000, 7010 and 7020. Each box type support element includes uprights 7006, 7014, 7035, 7036, 7037, 7038 and diagonal supports 7002, 7003, 7011, 7021, 7022 and bases 7001, 7005, 7007, 7023, 7024. The floor 35 is supported on base 7007.

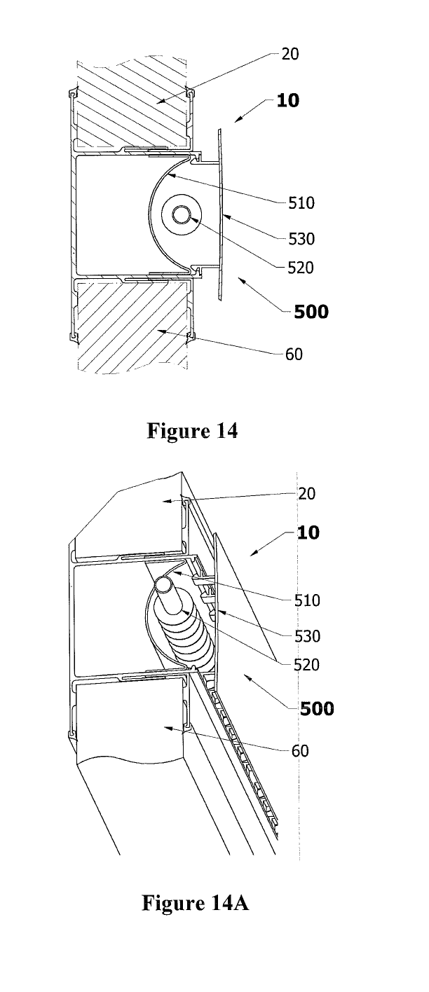

FIGS. 14 & 14A show a duct and spacer 10 having a heater 500 positioned within the internal space of the mid-portion 12 and where the removable sidewall 122 has been removed. The heater 500 includes a curved reflector 510 for directing heat from a heater element 520 outwardly from the internal space of the mid-portion 12. The heater element is preferably a hot water pipe with fins thereon.

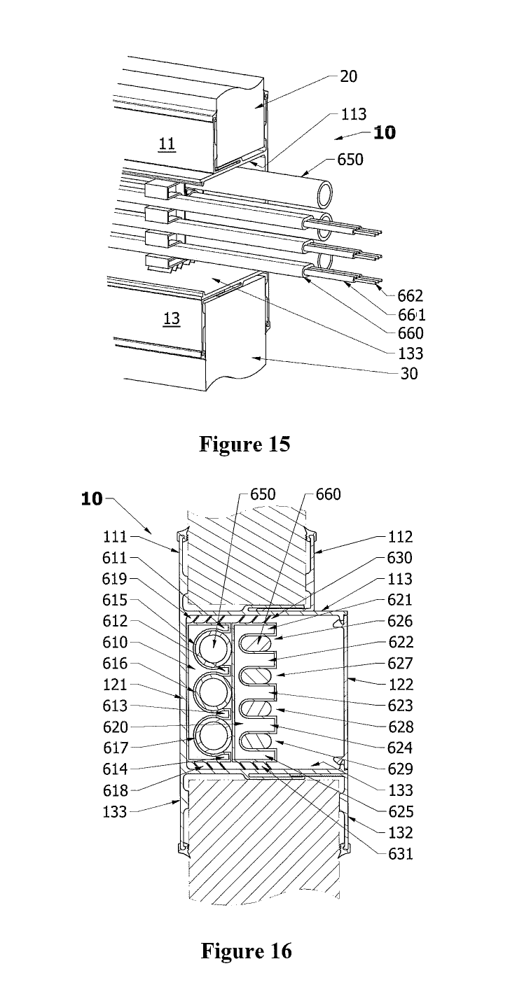

FIGS. 15 to 16 show a duct and spacer 10 having a clip mechanism for holding and restraining services within the interior space of the duct and spacer 10. The clip mechanism can be made of plastic or other material that press fits or clips within the interior space. As shown in FIGS. 15 and 16 there are two sets of clips 610, 620, one 610 for holding conduits 650 and the other 620 for holding cables 660, 661, 662. Clip 620 has spaced apart flanges 611, 612, 613, 614 defining three C shaped openings 615, 616, 617 that are dimensioned to snugly releasably hold therein conduits 650. The outer upper and lower surfaces of the clip 620 have flexible feet 618, 619 to allow for the clip to be slid and retained within the interior space of the duct and spacer 10. Clip 610 has spaced apart flanges 621, 622, 623, 624, 625 defining four C shaped openings 626, 627, 628, 629 that are dimensioned to snugly releasably hold therein cables 660. The outer upper and lower surface of the clip 610 has flexible feet 618, 619 to allow for the clip to be slid and retained within the interior space of the duct and spacer 10.

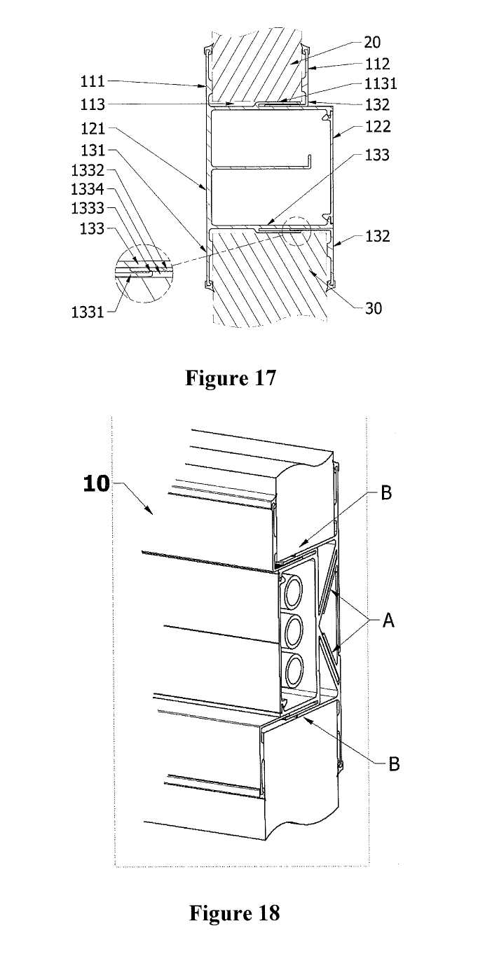

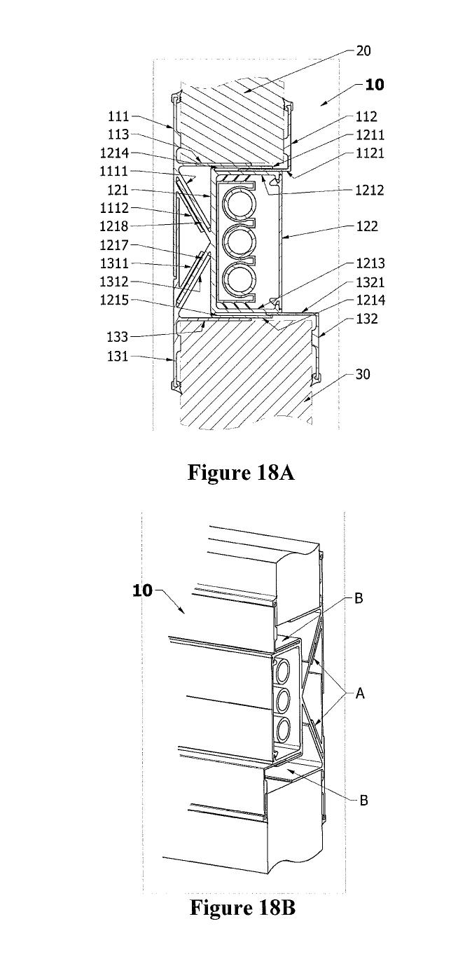

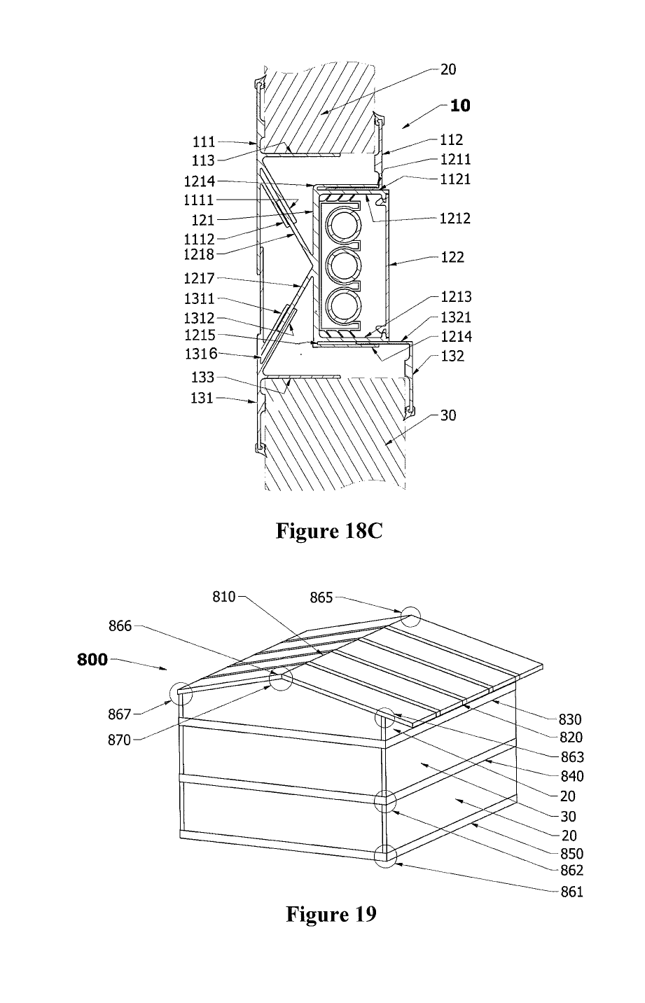

FIGS. 17 and 18 show a duct and spacer 10 that is able to be adjusted in width or height in order to be able to accommodate differing panel widths and also allow breadth of the combined panels with duct and spacer to be adjusted in order to allow the combined panels with duct and spacer to fit within a structure to which it is fitted. The ducting and spacer system is able to act as a variable spacer in order to gain extra wall height or width. For example where a wall is to be 2400 mm in height and each individual panel is only 1150 mm, the desired height maybe obtained by use of a duct and spacer with a height of 100 mm. It is envisaged that the duct and spacer is able to be adjusted such that the height of the duct and spacer can be altered in order to increase the overall height of a wall assembled from wall panels and the duct and spacer.

FIG. 17 shows an arrangement whereby the width of the elongate body can be adjusted in order to accommodate differing widths of wall panels 20, 30. As shown in FIG. 17 wall 20 is of lesser width than wall 30. Each base 113, 133 is able to be adjusted in order to increase or decrease the distance between corresponding legs 111, 112, 131, 132. Base 113 has an engaging portion 1131 that is raised a distance above the portion of the base 113 such that an engaging portion 132 is able to move and extend into the space between base 113 and the engaging portion 1131 such that movement of the engaging portion 132 within that space varies the distance between the legs 111 and 112. Similarly base 133 has an engaging portion 1331 that is raised a distance above the portion of the base 133 such that an engaging portion 1332 is able to move and extend into the space between base 133 and the engaging portion 1331 such that movement of the engaging portion 1332 within that space varies the distance between the legs 131 and 132. The movement of the corresponding engaging portions 1131, 1132; 1331, 1332 relative to one another can be controlled by a suitable ratchet type mechanism so that engaging portions are able to engage with one another in order to hold the legs at a desired distance apart once the required width has been obtained. In the close up shot in FIG. 17 it can be seen that the engaging portion 1332 has spaced apart teeth 1334 that are adapted to accommodate a corresponding tooth 1333 of the engaging portion 1331 of the base 133.

FIGS. 18 to 18c show a further variation of the adjustment capabilities of the duct and spacer 10 in that the duct and spacer 10 is able to be adjusted both vertically and horizontally such that the width and height of the duct and spacer 10 can be adjusted by adjusting elements A & B. The duct and spacer 10 has a side wall 121 with spaced apart flanges 1211, 1212 extending at right angles thereto where the space 1216 between the flanges accommodates in sliding fashion a portion 1121 of the leg 112. Similarly, side wall 121 further has spaced apart flanges 1213, 1214 extending at right angles thereto where the space 1215 between the flanges accommodates in sliding fashion a portion 1321 of the leg 132. Leg 111 has downwardly angled flanges 1111′ 1112′ (preferably angled at 45°) where the space between the flanges 1115 accommodates in sliding fashion an upwardly angled portion 1218 (preferably angled at 45°) of side wall 121. Leg 131 has upwardly angled flanges 1311, 1312′ (preferably angled at 45°) where the space 1316 between the flanges accommodates in sliding fashion a downwardly angled portion 1217 (preferably angled at) 45°) of side wall 121. Each flange 1111, 1112; 1211, 1212; 1213, 1214; 1311, 1312 has on the inside surfaces spaced apart teeth that are adapted to accommodate and engage with a corresponding tooth on the portions 1121, 1217, 1218, 1321 in order to allow controlled adjustable movement of the portions relative to the flanges so that vertical and horizontal movement of the legs 111, 112, 131, 132 relative to the side wall 121 can be obtained to thereby allow for the height and width of the duct and spacer to be adjusted. Other known height adjustment methods or techniques are envisaged. FIGS. 18 & 18a show the duct spacer in which the width of the duct and spacer has been adjusted. FIGS. 18b & 18c show the duct spacer in which the width and height of the duct and spacer has been adjusted.

FIG. 19 shows an embodiment of a building 800 in accordance with the invention incorporating embodiments of the duct and spacer system of the invention. The building has duct and spacers situated along the longitudinal length of the wall and ceiling panels. A ceiling duct and spacer 810 situated along the apex of the roof can accommodate service utilities such as air conditioning and lighting. The duct and spacer 820 situated along and adjacent to the eave lines can also accommodate service utilities such as air conditioning and lighting, similarly for the duct and spacer 830 situated between upper wall panel 20 and middle wall panel 30. The duct and spacer 840 situated between middle wall panel 30 and lower wall panel 20′ can accommodate service utilities such as plumbing, heating, electrical and communication cabling. The skirting duct and spacer 850 situated between lower wall panel 20′ and the floor can accommodate service utilities such as plumbing, heating, electrical and communication cabling. At each corner section of a duct and spacer are junction joiners 861, 862, 863, 865, 866 & 867.

FIG. 20 shows a duct and spacer system accommodating a light fitting 700. The light fitting 700 and light support 701 held and extending into the interior of the mid-portion of the elongate body 10. A light 702 is held by a light holding member 704 attached to the light support 701. A light diffuser 703 is releasably held in place by snap fit arrangement 705 in order to allow access to the light 702 and removal/replacement of the light fitting 700.

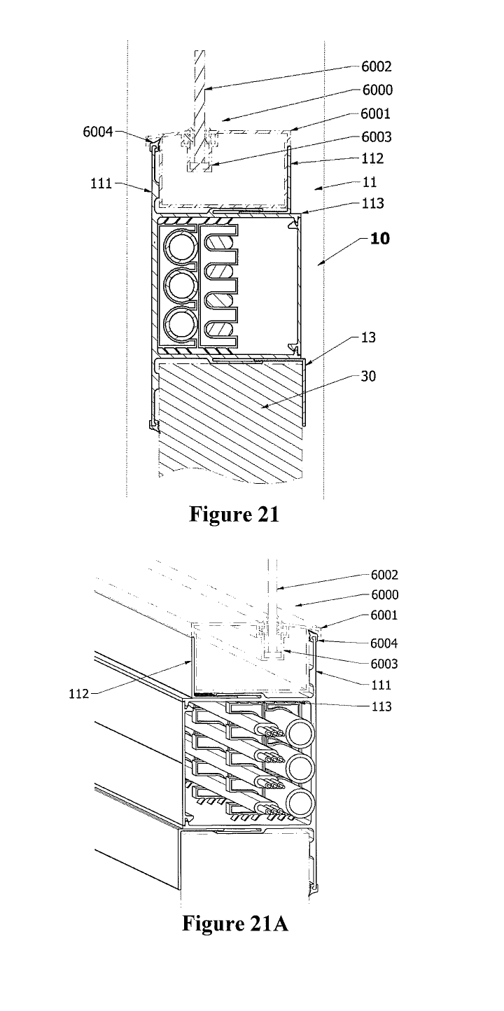

FIGS. 21 and 21A show an arrangement for windows installed into the duct and spacer system. The service duct and spacer 10 has an elongate body portion 10 having a window engaging part 11 spaced apart from a second panel engaging portion 13 with the mid-portion 12 situated between the first and second panel engaging portions 11, 13. The window engaging part 11 has a base 113 and two spaced apart legs 111, 112 extending away from the base 113 so as to define a window engaging area for accommodating and supporting a window frame 6000. The window frame 6000 has part 6001 that engages with and is supported by the two spaced apart legs 111, 112. The part 6001 has window support 6003 that supports a window 6002 (as is shown in FIGS. 21 and 21A). A seal 6004 attached to the leg 111 creates a water and/or air tight seal to protect the building from outside climatic conditions. A similar seal arrangement as shown in FIG. 21 is also shown in FIGS. 12 to 18, 22 and 23 (but not numbered as such). The window frame may have weep holes (not shown) to allow for the exit of any water or condensation that may be trapped by the window. A similar arrangement can be used in relation to a door frame.

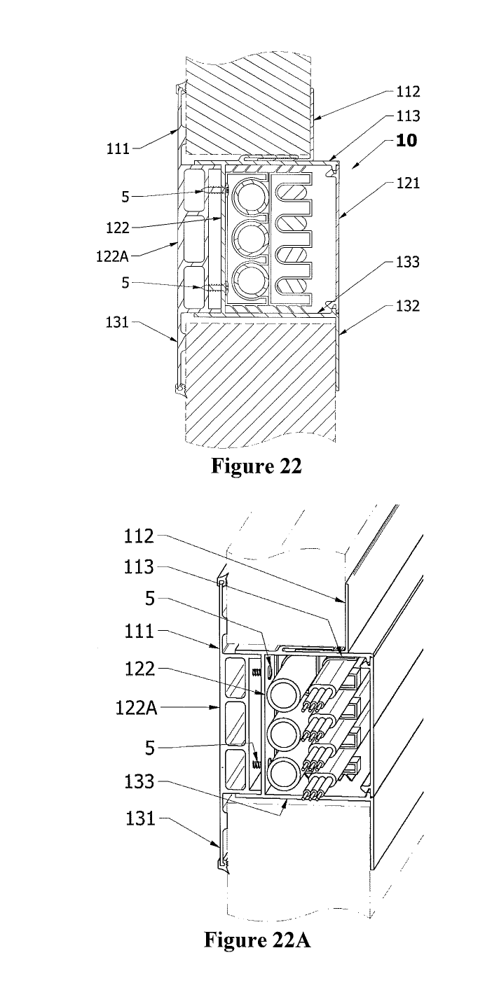

FIGS. 22 and 22A show a two piece duct and spacer 10 in which the elongate body portion has two parts 122 and 122A connected by screws 5. This arrangement allows for the replacement of part 122 that may contain pipes and cables with another part 122 having replacement pipes and cables or other utilities such as air-conditioning, lighting or heating components.

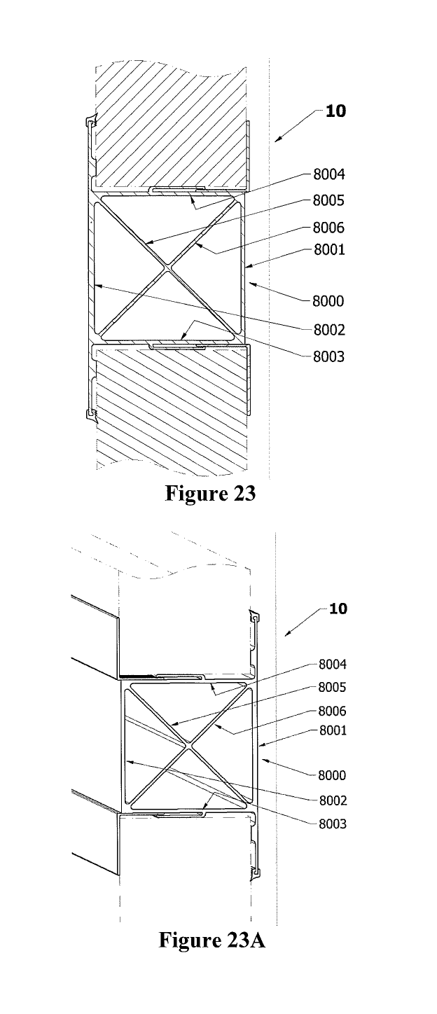

FIGS. 23 and 23A show a box structural arrangement 8000 of a duct and spacer 10. The box type arrangements were shown previously in FIGS. 13B to 13E. The box type arrangement 8000 in FIGS. 23 and 23A is where the interior space of the body portion includes diagonal supports 8005, 8006 situated between walls 8001, 8002, 8003, 8004 so as to provide a further structural integrity to the duct and spacer 10 such that the duct and spacer is able to handle greater loads. This type of box arrangement would be most suitable where the duct and spacer is used in a situation where more structural integrity is required.

The panel engaging portions can include seals to sealingly engage with the panels so as to create a fluid tight seal. The seal 6004 (FIG. 21) can just be situated only on the panel engaging portions 11, 13 that contact with a surface of the panels that are to be situated on the exterior of a building so as to create weather proof seal. The seals can be of any suitable material such as rubber, silicon, etc.

The duct and spacer system allows for the installation of roofs and ceilings with a void between the roof and the ceiling for services as being unnecessary. This is because the duct and spacer system of the invention allows services to be installed into the roof itself, thus removing the need for a lower ceiling and reducing cost.

The elongate body portions and service utilities therein are able to be joined to corresponding elongate body portions and corresponding utilities either in coaxial alignment or at right angles to one another using known connection arrangements such as “T”s or four way joiners, etc.

The duct and spacer system is a structural member that supports and holds panels in the desired arrangement, it is able to structurally support panels vertically or horizontally.

The ducting and spacer system of this invention is designed to cater for such requirements as insulation, fire rating and so-forth.

### Advantages

reduced cost of installation
quicker installation
reduced time for access and repair of ducted service utilities
wiring looms can be installed in place of individual wiring
services can be accessed as and when required
the services are held within the wall thickness and are thus less likely to sustain potential damage
no unsightly surface mountings
services can be inspected and repaired
able to act as a spacer between two wall panels
structurally support panels vertically or horizontally

### Variations

It will of course be realized that while the foregoing has been given by way of illustrative example of this invention, all such and other modifications and variations thereto as would be apparent to persons skilled in the art are deemed to fall within the broad scope and ambit of this invention as is herein defined in the appended claims.

1: A service duct and spacer system situated between two aligned panels of a building structure, the service duct and spacer system has an elongate body portion where the body portion includes:
(i) a first panel engaging portion adapted to engage and hold a longitudinal end of a first panel;
(ii) a second panel engaging portion adapted to engage and hold a longitudinal end of a second panel;
(iii) a mid-portion situated between the first and second panel engaging portions, the mid-portion defines an interior space in which service utilities are able to be located therein; and
(iv) a sidewall removably attached to the mid-portion so as to allow access into the interior space such that the service utilities can be maintained, introduced and/or removed from the body portion,
wherein, the service duct and spacer system structurally supports the panels vertically or horizontally when used either vertical or horizontal orientations.

2: The service duct and spacer system as claimed in claim 1, wherein the service utilities include electrical cables, telecommunication cables, water pipes, heating and air-conditioning ducts and other services.

3: The service duct and spacer system as claimed in claim 2, wherein the body portion includes preassembled electrical cables, telecommunication cables, water pipes, heating and air-conditioning ducts therein, whereby the preassembled electrical cables, telecommunication cables, water pipes, heating and air-conditioning ducts are adapted to be coupled with corresponding preassembled electrical cables, telecommunication cables, water pipes, heating and air-conditioning ducts situated within and adjacent body portion.

4: The service duct and spacer system as claimed in any one of the preceding claims, wherein the mid-portion has at least one tray extending longitudinally within the interior space.

5: The service duct and spacer system as claimed in any one of the preceding claims, wherein the first panel engaging portion has a base and two spaced upstanding legs such that the longitudinal end of the first panel is able to be situated between the two upstanding legs so that the first panel is able to be retained and held by the first panel engaging portion.

6: The service duct and spacer system as claimed in any one of the preceding claims, wherein the second panel engaging portion has a base and two spaced upstanding legs such that the longitudinal end of the second panel is able to be situated between the two upstanding legs so that the second panel is able to be retained and held by the second panel engaging portion.

7: The service duct and spacer system as claimed in any one of the preceding claims, wherein the mid-portion has at least a first sidewall extending between each base of the first and second panel engaging portions and the first sidewall is axial aligned with one of the upstanding leg of each first and second panel engaging portions.

8: The service duct and spacer system as claimed in claim 7, wherein the mid-portion has at least a second sidewall extending between each base of the first and second panel engaging portions and the second sidewall is axial aligned with an upstanding leg of each first and second panel engaging portions, such that the second sidewall is spaced apart from the first sidewall.

9: The service duct and spacer system as claimed in claim 8, wherein one of the sidewalls is removably attached to the mid-portion so that access can be gained to the interior space of the body portion.

10: The service duct and spacer system as claimed in claim 9, wherein the removable sidewall is snap fit to the body portion.

11: The service duct and spacer system as claimed in claim 10, wherein, the mid portion has a sidewall that is indented inwards relative to the upstanding legs of first and second panel engaging portions to define an open cavity sized and dimensioned to accommodate insulation therein.

12: The service duct and spacer system as claimed in any one of the preceding claims, the height of the elongate body portion is adjustable such that the combined height of the two aligned panels with the service duct and spacer system situated there between can be adjusted to suit and fit the height requirements of a wall or ceiling of a building structure.

13: The service duct and spacer system as claimed in any one of claims 1 to 11, wherein the width of the elongate body portion is adjustable such that the combined width of the two aligned panels with the service duct and spacer system situated there between can be adjusted to suit and fit the width requirements of a wall or ceiling of a building structure.

14: The service duct and spacer system as claimed in claim 12, wherein the ducting and spacer system acts as a spacer between the two wall panels such that extra wall height or wall width is able to be obtained.

15: The service duct and spacer system as claimed in claim 14, wherein each sidewall of the mid portion includes two parts that are able to be raised up and down relative to one other so as to achieve a desired height of the elongate body portion and be held and fixed at that height by fastening means.

16: The service duct and spacer system as claimed in claim 12, wherein the sidewalls of the mid portion are corrugated to allow the height of the elongate body portion to be adjusted by extension of the corrugations.

17: The service duct and spacer system as claimed in claim 12, wherein the elongate body portion includes a size adjustable spacer situated in one of the cavities of the first and second engaging wall portions, wherein the size adjustable spacer is positioned between the base of an engaging wall portion and the wall panel 20 so that as the size adjustable spacer expands the wall panel moves away from the elongate body portion allowing the overall height of the combined wall panels and duct and spacer to be adjusted.

18: The service duct and spacer system as claimed in claim 12, wherein the wall panels can be situated and held in place anywhere along the legs of the first and second engaging wall portions so that the wall panels can be held in place at a desired position therein in order to achieve the desired height of the combined wall panels with the duct and spacer system.

19: A service duct and spacer system situated between two aligned panels of a building structure, the service duct and spacer system has an extruded elongate body portion where the body portion includes:
a first panel engaging portion adapted to engage and hold a longitudinal end of a first panel, the first panel engaging portion has a base and two spaced upstanding legs such that the longitudinal end of the first panel is able to be situated between the two upstanding legs so that the first panel is able to be retained and held by the first panel engaging portion;
(ii) a second panel engaging portion adapted to engage and hold a longitudinal end of a second panel, the second panel engaging portion has a base and two spaced upstanding legs such that the longitudinal end of the second panel is able to be situated between the two upstanding legs so that the second panel is able to be retained and held by the second panel engaging portion; and
(iii) a mid-portion situated between the first and second panel engaging portions, the mid-portion defines an interior space in which service utilities are able to be located therein, the mid portion has at least a first sidewall extending between each base of the first and second panel engaging portions and the first sidewall is axial aligned with one of the upstanding leg of each first and second panel engaging portions; and

20: A service duct and spacer system situated between two aligned panels of a building structure, the service duct and spacer system has an extruded elongate body portion where the body portion includes:
an H-shaped first panel engaging portion for accommodating and holding a wall panel within the opening of the upper part of the H-shape: and (ii) a U-shaped second panel engaging portion where the upper portions of the legs of the U-shape extend into the opening of the lower part of the H-shape of the first engaging panel portion and are adjacent the lower part of the legs of the H-shaped first panel engaging portion.
wherein the outer surface of the U-shaped second engaging portion is dimensioned to fit within a cavity situated in the upper portion of a wall panel so that the wall panel is able to attached to the U-shaped second engaging portion.

21: The service duct and spacer system as claimed in any one of the preceding claims, wherein the elongate body is extruded, rolled, formed, pressed, 3D printing or formed using any other suitable manufacturing process.

22: The service duct and spacer system as claimed in any one of claims 19 to 20, wherein the service duct and spacer system structurally supports the panels vertically or horizontally when used either vertical or horizontal orientations.

23: The service duct and spacer system as claimed in any one of preceding claims, wherein the panel engaging portions include sealing means to sealing engage with the panels so as to create a fluid tight seal.

24: The service duct and spacer system as claimed in claim 23, wherein the sealing means are situated only the panel engaging portions that contact with a surface of the panels that are to be situated on the exterior of a building such that the duct and spacer system is weather proof.

25: The service duct and spacer system as claimed in any one of preceding claims, wherein the structural supporting of the panels vertically or horizontally is effected by elongate body portion including vertical, horizontal and/or diagonal support members.

26: The service duct and spacer system as claimed in claim 25, wherein the vertical, horizontal and/or diagonal support members are situated within the interior space of the elongate body portion.
